(19) United States
(12) Patent Application Publication
(10) Pub. No.: US 2015/0072239 A1
(43) Pub. Date: Mar. 12, 2015

(54) POSITIVE ELECTRODE ACTIVE MATERIAL, MANUFACTURING METHOD OF THE SAME, AND NONAQUEOUS ELECTROLYTE SECONDARY CELL

(71) Applicant: DENSO CORPORATION, Kariya-city (JP)

(72) Inventors: Syuuhei YOSHIDA, Tokoname-city (JP); Yuta SHIMONISHI, Chita-gun (JP); Daisuke SHIBATA, Tokai-city (JP)

(21) Appl. No.: 14/481,132

(22) Filed: Sep. 9, 2014

(30) Foreign Application Priority Data
Sep. 11, 2013 (JP) 2013-188064

(51) Int. Cl. H01M 4/136; H01M 4/04; H01M 4/1397; H01M 4/58; H01M 4/62

(52) U.S. Cl. CPC H01M 4/136; H01M 4/5825; H01M 4/625; H01M 4/1397; H01M 4/0471; H01M 4/0402; H01M 2004/028
USPC 429/224; 427/123

(57) ABSTRACT

A positive electrode active material includes a conductive matrix and a lithium metal compound of a polyanion structure provided on the surface of the conductive matrix. The lithium metal compound is expressed as Li_{α}M⁰_{β}X_{η}O_{4-γ}Z_{γ}, in which: M⁰ is one or more selected from Mn, Co, Ni, Fe, Cu, Cr, Mg, Ca, Zn, and Ti; X is one or more selected from P, As, Si, Mo, and Ge; Z is one or more selected from Al, Mg, Ca, Zn, and Ti, being optionally includable; α satisfies 0≦α≦2.0; β satisfies 0≦β≦1.5; η satisfies 1≦η≦1.5; and γ satisfies 0≦γ≦1.5.

### CROSS REFERENCE TO RELATED APPLICATION

This application is based on Japanese Patent Application No. 2013-188064 filed on Sep. 11, 2013, the disclosure of which is incorporated herein by reference.

### TECHNICAL FIELD

The present disclosure relates to a positive electrode active material, a manufacturing method of the same, and a nonaqueous electrolyte secondary cell.

### BACKGROUND

As a nonaqueous electrolyte secondary cell, a lithium ion secondary cell has been widely used.

A lithium ion secondary cell depends for its cell capacity size upon the kind of the positive electrode active material into and from which lithium ions are electrochemically intercalated and deintercalated. In such a lithium ion secondary cell, an inorganic oxide such as LiCoO₂ or LiMn₂O₄ is made into a powder form, to provide a positive electrode active material. The active material is used for the positive electrode.

A lithium ion secondary cell varies in cell capacity, cell voltage, input output characteristics, safety, and the like according to the material of the positive electrode active material. For this reason, different positive electrode active materials are used according to different uses of the secondary cell.

A positive electrode active material of a polyanion structure including a XO₄tetrahedron (X is P, As, Si, Mo, or the like) in the crystal structure is known to be stable in its structure. It is known that a material of an olivine structure such as LiFePO₄ which is one of polyanion structures is used as a positive electrode active material.

However, unfavorably, the positive electrode active material of the olivine structure such as LiFePO₄ is several digits smaller in electrical conductivity (ease of flow of electric current through the material surface), and Li diffusion coefficient (ease of movement of Li ions in the material) than LiCoO₂ and LiMn₂O₄, and has a larger material resistance.

It is known that such a problem related to electrical conduction is solved by covering the surface of the active material with carbon.

On the other hand, as for Li diffusion, it is known that the problem can be solved by nanoscale particle refinement. Further, there is proposed a synthesis method related to nanosizing of an olivine material. For example, in U.S. Pat. No. 6,528,033, there is disclosed a synthesis method in which carbon is mixed in a raw material source, and the reducing power of carbon or carbon as the nucleus of the product is used, resulting in nanosizing.

Specifically, in U.S. Pat. No. 6,528,033, a manufacturing method is described in an example that carbon in a larger amount than the amount of carbon of the final product is charged during mixing of raw materials. In the manufacturing method, the reaction proceeds in accordance with the following reaction formula. In other words, it is indicated that use of a carbon source as a reducing agent aims to accelerate the reaction for suppressing the particle growth.

FePO₄+0.5Li₂CO₃+0.5C→LiFePO₄+0.5CO₂+CO

Currently, the solving method of the problem allows LiFePO₄ of an olivine structure to be applied as a positive electrode material.

However, in uses requiring an energy density such as plug-in hybrid vehicle (PHV) use, the low electrical potential imposes a limit on the intended use. Accordingly, the electrical potential is required to be raised while keeping the olivine structure.

The positive electrode electrical potential is theoretically determined by the transition metal to be used. For a higher electrical potential, LiMnPO₄ obtained by substituting Mn for Fe has been under study.

### SUMMARY

LiMnPO₄ is still lower in electrical conductivity and Li diffusion coefficient than LiFePO₄. This necessitates further uniform carbon coating and particle refinement. The synthesis method and the like described above are assumed to be substantially applied to LiFePO₄ as an olivine structure material. Namely, even when such methods are tried to be performed in manufacturing of LiMnPO₄, the primary particle is larger than that of LiFePO₄, and the uniformity of carbon coating is reduced.

Specifically, the problem of LiMnPO₄ described above is a characteristic problem derived from the electron orbit characteristics of Mn. The 3d orbit of Mn²⁺is a half closed shell, and hence is stable. Thus, during the synthesis reaction of LiMnPO₄, the Mn intermediate does not undergo a change in valency. For this reason, the particle growth of the intermediate proceeds. This results in a delay of formation of LiMnPO₄ due to the attack of Li ions on the Mn intermediate. As a result, the formation of LiMnPO₄ requires a reaction for a long time, or a reaction at high temperatures. Then, a reaction for a long time allows the particle growth of the Mn intermediate to proceed. Whereas, a reaction at high temperatures results in sintering (necking) of the Mn intermediate or the resulting LiMnPO₄. As a result, the particles become coarser. In addition, the Mn intermediates not fully reacted are left in the product.

In contrast, for Fe included in LiFePO₄, Fe²⁺is not in a half closed shell configuration. This effects a change in valency so as to achieve the half-closed shell and stable state of Fe³⁺. Accordingly, during the synthesis reaction of LiFePO₄, the Fe intermediate undergoes a change in valency of from 2 to 3, and is refined in particle size with a change in structure of the intermediate. This facilitates attack of Li ions on the Fe intermediate, which allows the synthesis of LiFePO₄ to proceed smoothly. As a result, LiFePO₄ can be synthesized with a prescribed particle size by the already proposed synthesis method.

The present disclosure is made in view of the foregoing circumstances. It is an object of the present disclosure to provide a positive electrode active material having a lithium metal compound of a polyanion structure with a small particle size, a manufacturing method of the positive electrode active material, and a nonaqueous electrolyte secondary cell.

According to a first aspect of the present disclosure, a positive electrode active material has a conductive matrix, and a lithium metal compound of a polyanion structure provided on the surface of the conductive matrix. The lithium metal compound is expressed as Li_{α}M⁰_{β}X_{η}O_{4-γ}Z_{γ}, in which: M⁰ is one or more selected from Mn, Co, Ni, Fe, Cu, Cr, Mg, Ca, Zn, and Ti; X is one or more selected from P, As, Si, Mo, and Ge; Z is one or more selected from Al, Mg, Ca, Zn, and Ti, being optionally includable; 0≦α≦2.0; 0≦β≦1.5; 1≦η≦1.5; and 0≦γ≦1.5.

According to a second aspect of the present disclosure, a method for manufacturing a positive electrode active material is a method for manufacturing a positive electrode active material having a lithium metal compound of a polyanion structure granulated on the surface of a conductive matrix. The lithium metal compound is expressed as Li_{α}M⁰_{β}X_{η}O_{4-γ}Z_{γ}, in which: M⁰ is one or more selected from Mn, Co, Ni, Fe, Cu, Cr, Mg, Ca, Zn, and Ti; X is one or more selected from P, As, Si, Mo, and Ge; Z is one or more selected from Al, Mg, Ca, Zn, and Ti, being optionally includable; 0≦α≦2.0; 0≦β≦1.5; 1≦η≦1.5; and 0≦γ≦1.5. The method includes: preparing a mixture solution in which an M compound as a M⁰ source, an X compound as an X source, a Z compound as a Z source, and the conductive matrix are dispersed; forming an intermediate made of a hydrate of M⁰ from the M compound; and forming the lithium metal compound by reacting a Li compound as a Li source and the intermediate with each other by a heat treatment.

According to a third aspect of the present disclosure, the nonaqueous electrolyte secondary cell includes: a positive electrode having at least one of the positive electrode active material according to the first aspect, and the positive electrode active material manufactured by the manufacturing method according to the second aspect; a negative electrode; and an electrolyte.

The positive electrode active material according to the first aspect has a structure having the conductive matrix, and the lithium metal compound of the polyanion structure provided on the surface of the conductive matrix. By being provided on the surface of the conductive matrix, the lithium metal compound is restricted from being coarsened in particle size. Namely, the positive electrode active material according to the first aspect can restrict coarsening of lithium metal compound particles contributing to the electrode reaction, and hence the positive electrode active material has excellent electrical potential characteristics.

In the method for manufacturing a positive electrode active material according to the second aspect, the intermediate is formed on the surface of the conductive matrix, then in that state, the lithium metal compound is formed. In other words, it is possible to manufacture the positive electrode active material described above. Namely, it is possible to manufacture the positive electrode active material exerting the foregoing effect.

The nonaqueous electrolyte secondary cell according to the third aspect uses the positive electrode active material described above for a positive electrode. The positive electrode can exert the foregoing effect. For this reason, inclusion of the positive electrode excellent in electrical conductivity and Li diffusion property, and having a high electrical potential result in a secondary cell excellent in cell characteristics.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a diagram illustrating a schematic cross section of a coin type nonaqueous electrolyte secondary cell according to an embodiment of the present disclosure;

FIG. 2A is a SEM photograph of a positive electrode active material of example 1;

FIG. 2B is a line diagram of the SEM photograph of FIG. 2A;

FIG. 3A is a SEM photograph of a positive electrode active material of comparative example 1;

FIG. 3B is a line diagram of the SEM photograph of FIG. 3A;

FIG. 4 is a graph showing the measurement results of the positive electrode capacities of the cells of the example 1 and the comparative example 2; and

FIG. 5 is a flowchart illustrating an example of a process of producing a positive electrode active material according to an embodiment of the present disclosure.

### DETAILED DESCRIPTION

### Non-Aqueous Electrolyte Secondary Cell

Hereinafter, embodiments of the present disclosure will be described using a nonaqueous electrolyte secondary cell.

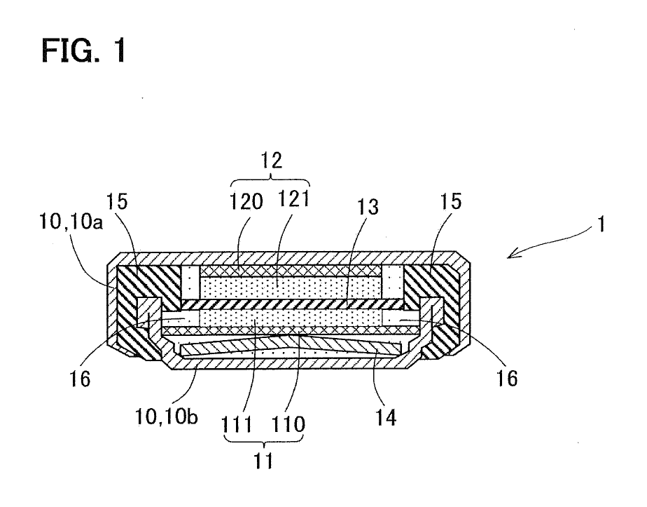

The schematic cross section of a coin type nonaqueous electrolyte secondary cell, which is an embodiment of a positive electrode active material and a nonaqueous electrolyte secondary cell of the present disclosure, is shown in FIG. 1.

A coin type nonaqueous electrolyte secondary cell 1 has a structure whose inside is closed by a coin type case 10, a sealing plate 14, and a gasket 15. For example, the case 10 includes a first case member 10a and a second case member 10b. The coin type nonaqueous electrolyte secondary cell 1 includes a positive electrode 11, a negative electrode 12, and a separator 13 accommodated therein. The positive electrode 11 has a positive electrode active material layer 111 and a positive electrode collector 110. The negative electrode 12 has a negative electrode active material layer 121 and a negative electrode collector 120. The positive electrode 11 and the negative electrode 12 are opposed to each other across the separator 13. The positive electrode 11, the negative electrode 12, and the separator 13 are arranged so that the positive electrode active material layer 111 and the negative electrode active material layer 121 are in contact with the separator 13. An electrode cell including the positive electrode 11, the negative electrode 12, and the separator 13 is accommodated in the inside of the coin type case 10 together with an electrolyte 16.

The positive electrode active material layer 111 includes a positive electrode active material capable of occluding and releasing lithium ions. The negative electrode active material layer 121 includes a negative electrode active material capable of occluding and releasing lithium ions. The electrolyte 16 is obtained by dissolving a supporting salt in an organic solvent (nonaqueous solvent).

In the positive electrode 11 and the negative electrode 12, an electrode mixture material containing conventionally known additives (such as a conductive agent and a binding agent), in addition to the electrode active material, is suspended and mixed in an appropriate solvent, resulting in a slurry. The resulting slurry is applied on one side or both sides of the collector 110, 120, and is dried, thereby to form the electrode active material layer 111, 121.

In an embodiment, the positive electrode active material contained in the positive electrode 11 has a conductive matrix, and a lithium metal compound of a polyanion structure provided on the surface of the conductive matrix. The lithium metal compound is expressed as Li_{α}M⁰_{β}X_{η}O_{4-γ}Z_{γ}, in which: M⁰ is one or more selected from Mn, Co, Ni, Fe, Cu, Cr, Mg, Ca, Zn, and Ti; X is one or more selected from P, As, Si, Mo, and Ge; Z is one or more selected from Al, Mg, Ca, Zn, and Ti, which is optionally includable; α satisfies 0≦α≦2.0; β satisfies 0≦β≦1.5; η satisfies 1≦η≦1.5; γ satisfies 0≦γ≦1.5.

The positive electrode active material has the conductive matrix, and the lithium metal compound (Li_{α}M⁰_{β}X_{η}O_{4-γ}Z_{γ}). The lithium metal compound causes an electrode reaction in which lithium ions are occluded and released. Namely, similar to the positive electrode active material of a conventional secondary cell, a cell capacity is realized by transfer of lithium ions. The conductive matrix contributes to the movement of electrons at the lithium metal compound provided on its surface, and enhances the electrical conductivity of the positive electrode active material.

By being provided on the surface of the conductive matrix, the lithium metal compound can be restricted from being coarsened in particle size. As a result, in the positive electrode active material, the lithium metal compound contributing to the electrode reaction is restricted from being coarsened in particle size. Accordingly, the lithium metal compound provides excellent electrical potential characteristics.

In the embodiment, the lithium metal compound in the positive electrode active material is a compound represented by a chemical formula of Li_{α}M⁰_{β}X_{η}O_{4-γ}Z_{γ}, where Z is optionally included. In other words, the lithium metal compound may be a compound represented by a chemical formula of Li_{α}M⁰_{β}X_{η}O₄.

In an embodiment of the positive electrode active material, the lithium metal compound is represented by Li_{α}Mn_{∈}M¹_{1-∈}X_{η}O_{4-γ}Z_{γ}, where ∈ is 0.6 or more. In this case, M¹ is one or more selected from Co, Ni, Fe, Cu, Cr, Mg, Ca, Zn, and Ti; X is one or more selected from P, As, Si, Mo, and Ge, being optionally includable; Z is one or more selected from Al, Mg, Ca, Zn, and Ti; α satisfies 0≦α≦2.0; β satisfies 0≦β≦1.5; η satisfies 1≦η≦1.5; and γ satisfies 0≦γ≦1.5.

When the lithium metal compound is a compound in which M⁰ contains Mn of a transition metal in an atomic ratio of 0.6 or more, the lithium metal compound can have a high electrical potential. This results in an increase in electrical potential of the positive electrode using the positive electrode active material. More preferably, the lithium metal compound is a compound of an olivine structure represented by Li_{α}MnX_{η}O₄.

The conductive matrix of the positive electrode active material has no restriction on the material and the form. Examples of the material of the conductive matrix are carbon, metal, and conductive resin. Examples of the form of the conductive matrix are porous body, and fiber (fiber assembly) such as woven fabric or nonwoven fabric. Specifically, the examples of the form of the conductive matrix are a carbon fiber formed of a carbon nanotube, PAN type and pitch type carbon fibers, and aluminum type fibers, and assemblies thereof.

In an embodiment, the conductive matrix of the positive electrode active material is formed of carbon. When the conductive matrix is formed of carbon, the electrical conductivity to the lithium metal compound provided on the surface of the conductive matrix improves.

In an embodiment, the conductive matrix of the positive electrode active material is a carbon fiber assembly. When the conductive matrix is the carbon fiber assembly, the lithium metal compound is granulated in fine particles on the fiber surface. Further, when the conductive matrix is the carbon fiber assembly, the surface area increases. Therefore, a further larger amount of the lithium metal compound is granulated. Namely, the positive electrode active material can have a larger amount of lithium metal compound effecting the electrode reaction.

In an embodiment, the lithium metal compound of the positive electrode active material is a primary particle with a size of 500 nm or less. When the lithium metal compound is a primary particle with a size of 500 nm or less, diffusion of Li into the lithium metal compound becomes more likely to occur, i.e., the Li diffusion property improves. As a result, the positive electrode active material that does not obstruct occlusion and releasing of Li ions is provided.

The positive electrode active material layer 111 of the positive electrode 11 has a conductive agent and a binding agent, in addition to the positive electrode active material.

Examples of the conductive material of the positive electrode are graphite fine particles, carbon blacks such as acetylene black, ketjen black, and carbon nanofiber, amorphous carbon fine particles of needle coke and the like. However, the conductive material is not limited to these examples.

Examples of the binding agent of the positive electrode are PVDF, EPDM, SBR, NBR, and fluorine rubber. However, the binding agent of the positive electrode is not limited to these examples.

As the solvent for the positive electrode mixture material, generally, an organic solvent for dissolving a binding agent is used. Examples thereof are NMP, dimethylformamide, dimethylacetamide, methyl ethyl ketone, cyclohexanone, methyl acetate, methyl acrylate, diethyltriamine, N—N-dimethylaminopropylamine, ethylene oxide, and tetrahydrofuran. However, the solvent is not limited to these examples. Alternatively, a dispersant, a thickener, and the like may be added to water, thereby to make the active material into a slurry by PTFE or the like.

As the positive electrode collector 110, for example, those obtained by forming a metal such as aluminum or stainless steel, such as, foil, mesh, punched metal, and formed metal formed into sheets, and the like are used.

For the negative electrode active material of the negative electrode 12, conventionally known negative electrode active materials can be used so long as they are compounds capable of occluding and releasing lithium ions. As the negative electrode active material, at least one element of Li, Sn, Si, Sb, Ge, and C can be included. Of the negative electrode active materials, C is preferably a carbon material capable of occluding/releasing electrolyte ions of the lithium ion secondary cell (i.e., having a Li occluding ability), and is more preferably amorphous coated natural graphite.

Whereas, of the negative electrode active materials, Sn, Sb, and Ge are alloy materials particularly showing much changes in volume. The negative electrode active materials may form alloys with other metals such as Ti—Si, Ag—Sn, Sn—Sb, Ag—Ge, Cu—Sn, Ni—Sn, and the like.

Examples of the conductive material of the negative electrode 12 are carbon materials, metal powders, conductive polymers, and the like. From the viewpoints of the electrical conductivity and the safety, carbon materials such as acetylene black, ketjen black, and carbon black are preferably used.

Examples of the binding material of the negative electrode 12 are polytetrafluoroethylene (PTFE), polyvinylidene fluoride (PVDF), fluorine resin copolymer (ethylene tetrafluoride/propylene hexafluoride copolymer) SBR, acrylic type rubbers, fluorine type rubbers, polyvinyl alcohol (PVA), styrene/maleic acid resin, polyacrylic acid salts, carboxyl methyl cellulose (CMC).

Examples of the solvent of the negative electrode 12 are organic solvents such as N-methyl-2-pyrrolidone (NMP), and water.

As the negative electrode collector 120, conventionally known collectors can be used. For example, foil or mesh made of copper, stainless steel, titanium or nickel is used.

The supporting salt of the electrolyte 16 is not limited to a specific one, but is desirably at least one of inorganic salts selected from LiPF₆, LiBF₄, LiClO₄, and LiAsF₆, derivatives of the inorganic salts, organic salts selected from LiSO₃CF₃, LiC(SO₃CF₃)₃, and LiN(SO₂CF₃)₂, LiN(SO₂C₂F₅)₂, LiN(SO₂CF₃)(SO₂C₄F₉), and derivatives of the organic salts. The supporting salts can make the cell performances more excellent, and can also keep the cell performances at a further higher level in the temperature region other than room temperature. The concentration of the supporting salt is not limited to a specific concentration, but is determined appropriately according to the intended uses in consideration of the types of the supporting salt and the organic solvent.

The organic solvents (nonaqueous solvents) for dissolving the supporting salt are not limited to a specific one so long as they are organic solvents for use as common electrolytes. Examples of the organic solvents are carbonates, hydrocarbon halides, ethers, ketones, nitriles, lactones, and oxolane compounds. Particularly, proper examples thereof are propylene carbonate, ethylene carbonate, 1,2-dimethoxyethane, dimethyl carbonate, diethyl carbonate, ethyl methyl carbonate, vinylene carbonate, and the like, and mixed solvents thereof. Of the organic solvents mentioned as examples, particularly, one or more nonaqueous solvents selected from the group consisting of carbonates and ethers are preferably used, because use thereof results in excellent solubility, dielectric constant, and viscosity of the supporting salt, and high charging and discharging efficiency of the cell.

The separator 13 serves to establish an electrical insulation between the positive electrode 11 and the negative electrode 12, and to hold the electrolyte 16. For example, a porous synthetic resin film, particularly, a porous film of a polyolefin type polymer (polyethylene or polypropylene) is preferably used. Incidentally, the separator 13 ensures the insulation between the positive electrode 11 and the negative electrode 12, and hence is preferably made still larger than the positive electrode 11 and the negative electrode 12.

The coin type nonaqueous electrolyte secondary cell 1 can be made of additionally required elements, in addition to the foregoing elements. The coin type nonaqueous electrolyte secondary cell 1 is formed in a coin type in the embodiments, but has no particular restriction on its shape. Other than the coin type cell, there can be adopted cells in various shapes such as cylindrical type and angular type, and amorphous cells sealed in a laminate resin.

[Manufacturing Method of Positive Electrode Active Material]

A positive electrode active material having a lithium metal compound (Li_{α}M⁰_{β}X_{η}O_{4-γ}Z_{γ}) of a polyanion structure granulated on the surface of a conductive matrix can be manufactured in the following manner.

First, a step of preparing a mixture solution in which an M compound as an M⁰ source, an X compound as an X source, a Z compound as a Z source, and a conductive matrix are dispersed (e.g., S1 in FIG. 5). In the step of preparing, the mixture solution of the M compound as the M⁰ source, the X compound as the X source, the Z compound as the Z source, and the conductive matrix is prepared. By performing the step of preparing the mixture solution, in the subsequent step, it is possible to form an intermediate for causing a reaction with a lithium compound, thereby to form a lithium metal compound. Incidentally, the M compound as the M⁰ source, the X compound as the X source, and the Z compound as the Z source are compounds containing elements of M⁰, X, and Z, respectively, and are compounds serving as the supply sources of respective elements for forming the lithium metal compound.

As the M compound, the X compound, and the Z compound, compounds that are used in manufacturing of conventional positive electrode active materials may be used. As a Li compound described later, compounds that are used in manufacturing of conventional positive electrode active materials may be used.

Examples of the M compound, as the Mn source, are MnSO₄, MnSO₄.5H₂O, Mn(NO₃)₂.6H₂O, Mn(CH₃COO)₂.4H₂O, and MnCO₃. Examples of the X compound, as the P source, are H₃PO₄, (NH₄)2HPO₄, NH₄H₂PO₄, and Li₃PO₄. Examples of the Li compound, as the Li source, are LiOH.H₂O, LiOH, Li₂SO₄.H₂O, Li₃PO₄, LiNO₃, LiCl, Li₂CO₃, CH₃COOLi, and Li₃PO₄.

Preparation of the mixture solution can be performed by charging the M compound as the M⁰ source, the X compound as the X source, the Z compound as the Z source, and the conductive matrix in a solvent. In this step, the order of charging of respective compounds in the solvent has no restriction. Namely, to form the mixture solution, the M compound as the M⁰ source, the X compound as the X source, the Z compound as the Z source, and the conductive matrix may be charged in the solvent at a time, or may be charged successively. Further, the charging order thereof also has no restriction.

Further, in the step of preparing the mixture solution, stirring is preferably performed during charging and after charging in order to prepare the solution in which the M compound, the X compound, the Z compound, and the conductive matrix are uniformly mixed.

Then, a step of forming an intermediate including a hydrate of M⁰ from the M compound is performed (e.g., S2 in FIG. 5). The intermediate reacts with a Li compound to form a lithium metal compound in the subsequent step (e.g., S3 in FIG. 5).

In the step of forming the intermediate, the intermediate is generated in the mixture solution. In the mixture solution, the conductive matrix is present, and thus the intermediate is generated on the surface of the conductive matrix. The intermediate generated on the surface of the conductive matrix becomes a lithium metal compound in that state in the subsequent step.

The formation of the intermediate was confirmed as a result of performing sampling before a heat treatment in the example 1 described later, and performing an examination by an X-ray diffraction (XRD) after vacuum drying. Specifically, MnHPO₄.3H₂O, Mn[PO₃(OH)].3H₂O, Mn₅(PO₄)₂[PO₃(OH)]₂.4H₂O, Mn₃(PO₄)₂.8H₂O, and MnO(OH) were identified by the XRD.

The step of forming the intermediate is not limited to a specific step so long as an intermediate made of a hydrate of M⁰ can be generated.

Examples of the method for forming the intermediate are a chemical oxidation method, an electrolytic oxidation method, and a vapor phase oxidation method. The chemical oxidation method may be preferably used.

In an embodiment, the step of forming the intermediate preferably proceeds at 60° C. or less. Namely, it is preferable that the temperature of the mixture solution is kept at 60° C. or less. As a result, the particle growth of the resulting intermediate is inhibited, and thus the increase in the particle size of the lithium metal compound to be formed in the subsequent step is restricted. When the temperature of the mixture solution in the step of forming the intermediate exceeds 60° C., the particle size of the intermediate becomes too large. As a result, the particle size of the lithium metal compound to be formed in the subsequent step becomes too large.

In an embodiment, in the step of forming the intermediate, the mixture solution preferably has a pH of 2 to 6.5. The adjustment of the pH of the mixture solution within this range can control the formation of the intermediate. When the pH is smaller than 2, the reaction of forming the intermediate ceases to sufficiently proceed (i.e., the amount of the intermediate formed is reduced). When the pH exceeds 6.5, the particle size of the intermediate becomes too large, and thus the particle size of the lithium metal compound to be formed in the subsequent step becomes too large.

In an embodiment, the mixture solution is preferably adjusted in pH by an organic acid. Since the organic acid does not contain an inorganic element, the lithium metal compound formed by a heat treatment does not contain an inorganic element which is an impurity.

When the organic acid is subjected to a heat treatment at the subsequent step, it is deposited as carbon on the surface of the primary particle of the lithium metal compound. Then, the carbon deposited on the surface functions in the same manner as the carbon coated on the conventional positive electrode active material. In other words, the carbon exerts an effect of enhancing the electrical conductivity.

The organic acid is preferably an organic acid having an oxygen-containing group. Use of an organic acid having an oxygen-containing group promotes a hydrogen bond with the conductive matrix, resulting in an enhancement of the dispersibility and the adhesion.

Although the organic acid is not limited to a specific one, it is preferably a polybasic carboxylic acid. When the organic acid is a polybasic carboxylic acid, the organic acid is more likely to be deposited on the surface of the conductive matrix. Any polybasic carboxylic acids are acceptable so long as they have two or more carboxyl groups per molecule. Examples of the polybasic carboxylic acid are citric acid, ascorbic acid, malic acid, lactic acid, succinic acid, fumaric acid, maleic acid, fumaric acid, malonic acid, adipic acid, terephthalic acid, isophthalic acid, sebacic acid, dodecanedioic acid, diphenyl ether-4,4′-dicarboxylic acid, pyridine-2,6-dicarboxylic acid, butane-1,2,4-tricarboxylic acid, cyclohexane-1,2,3-tricarboxylic acid, benzene-1,2,4-tricarboxylic acid, naphthalene-1,2,4-tricarboxylic acid, butane-1,2,3,4-tetracarboxylic acid, cyclobutane-1,2,3,4-tetracarboxylic acid, benzene-1,2,4,5-tetracarboxylic acid, 3,3′,4,4′-benzophenone tetracarboxylic acid, and 3,3′,4,4′-diphenyl ether tetracarboxylic acid.

In an embodiment, the conductive matrix preferably has a DBP (dibutyl phthalate) oil absorption amount of 70 ml/100 g or more. The DBP oil absorption amount is an index indicating the degree of the structure resulting from connection or aggregation between particles from the amount of DBP required for filling the voids of carbon black to be deposited.

When the DBP oil absorption amount of the conductive matrix is 70 ml/100 g or more, the conductive matrix allows a sufficient amount of lithium metal compound to be deposited on its surface.

Thereafter, a step of heat treatment is performed. Namely, the step of forming the lithium metal compound by reacting the Li compound as the Li source and the intermediate with each other through a heat treatment is performed (e.g., S3 in FIG. 5). In the step of forming the lithium metal compound, the intermediate and the Li compound are reacted with each other by the heat treatment, thereby to form the lithium metal compound.

The heat treatment to be performed in the step of forming the lithium metal compound has no restriction so long as it is a heat treatment capable of forming the lithium metal compound from the intermediate and the Li compound.

The Li compound which reacts with the intermediate in the step of forming the lithium metal compound may be supplied at any step so long as it is supplied in a state reactable with the intermediate during the heat treatment. Namely, the Li compound may be charged into the mixture solution in the similar manner to the other compounds in the step of preparing the mixture solution, or mixed therein after the step of forming the intermediate.

In an embodiment, in the manufacturing method, preferably, the lithium metal compound of the positive electrode active material is expressed as Li_{α}Mn_{∈}M¹_{1-∈}X_{η}O_{4-γ}Z_{γ}, where ∈ is 0.6 or more. In this case, M¹ is one or more selected from Co, Ni, Fe, Cu, Cr, Mg, Ca, Zn, and Ti; X is one or more selected from P, As, Si, Mo, and Ge, being optionally includable; Z is one or more selected from Al, Mg, Ca, Zn, and Ti; α satisfies 0≦α≦2.0; β satisfies 0≦β≦1.5; η satisfies 1≦η≦1.5; and γ satisfies 0≦γ≦1.5.

Namely, as the lithium metal compound (Li_{α}M⁰_{β}X_{η}O_{4-γ}Z_{γ}) of a polyanion structure, when the lithium metal compound is a compound in which M⁰ contains Mn of a transition metal in an atomic ratio of 0.6 or more, an intermediate of a hydrate formed of Mnₓ(PO₄)_{y}(H₂O)_{z} of Mn²⁺ can be formed, and the particle growth of the intermediate can be allowed to proceed. As a result, the effect of suppressing the particle growth of the lithium metal compound resulting from the formation of the intermediate can be more exhibited.

FIG. 5 illustrates an example of the manufacturing method of the positive electrode active material described hereinabove. Although not illustrated in FIG. 5, any other step may be performed. For example, a product produced in the step of forming the lithium metal compound may be crushed after the step of forming the lithium metal compound, to produce the positive electrode active material.

### EXAMPLES

Hereinafter, examples of the present disclosure will be described.

As the examples, a positive electrode active material formed of LiMnPO₄, and a lithium ion secondary cell using the same were fabricated. Incidentally, the lithium ion secondary cell fabricated in the examples is the cell shown in FIG. 1.

### Example 1

### Fabrication of Positive Electrode Active Material

LiOH as the Li source, (NH₄)₂PO₄ as the P source, and MnCO₃ as the Mn source were weighed so that Li:Mn:P is 1:1:1 by mole ratio. A vapor-grown carbon fiber (conductive matrix, made by SHOWA DENKO K.K., trade name: VGCF, DBP oil absorption amount: 331 mg/100 g) was prepared so as to be in an amount of 0.2 mol.

The raw materials and the carbon fiber described above were charged into a ball mill together with water, and were wet mixed under the conditions of 400 rpm and for 5 minutes. This step corresponds to the step of preparing a mixture solution.

Then, the wet mixture of the raw materials and carbon fiber was charged into a citric acid aqueous solution (organic acid aqueous solution), and stirred for 2 hours while keeping the solution temperature at 60° C. or less, resulting in a uniformly dispersed solution. The pH of the organic acid aqueous solution under stirring was 3.4. For the citric acid aqueous solution, a 3% citric acid aqueous solution was used, and added so as to have a solid content ratio of 80%. Incidentally, the solid content ratio indicates the ratio occupied by the mass of the solid content (the respective raw materials and carbon fiber) based on the total mass as 100%. This step corresponds to the step of forming an intermediate, i.e., the step of forming a lithium metal compound.

After two-hour stirring, the solution was transferred into a heat treatment furnace, and raised in temperature to 650° C. at a heating rate of 5° C./minute under an Ar atmosphere, and was held for 2 hours. This step corresponds to the step of heat treatment.

Then, the solution was cooled to the room temperature, and was subjected to a crushing treatment, resulting in the positive electrode active material of the example 1.

[Fabrication of Lithium Ion Secondary Cell]

The positive electrode active material prepared as described above, acetylene black as a conductive material, and PVDF as a binder were weighed so as to have a mass ratio of 91:2:7, and were mixed in an agate mortar, thereby to prepare a positive electrode active material paste.

The prepared positive electrode active material paste was applied to a positive electrode collector formed of aluminum foil (thickness: 5 μm) as a collector, and was vacuum dried. Thus, a positive electrode having the positive electrode active material layer on its surface was produced.

A metal lithium of the negative electrode active material was attached to the negative electrode collector formed of copper foil, thereby to produce a negative electrode having a negative electrode active material layer on its surface.

Using the produced positive electrode, and the produced negative electrode (counter electrode) formed of metal lithium, and an electrolyte, a coin type lithium ion secondary cell (CR2032 type shown in FIG. 1) was assembled in a dry box.

Incidentally, the electrolyte is prepared by dissolving LiPF₆ in a mixed solvent of 30 vol % of ethylene carbonate (EC), 30 vol % of dimethyl carbonate (DMC), and 30 vol % of ethyl methyl carbonate (EMC) so as to achieve 1 mol/liter. Further, to the electrolyte, vinylene carbonate (VC) is added as an additive so as to achieve 1 mass %.

In this way, the lithium ion secondary cell of the example 1 was fabricated.

### Example 2

In the example 2, a positive electrode active material and a lithium ion secondary cell were produced in the similar manner to the example 1, except that the timing of charging carbon fiber was different.

In the example 2, the respective materials were wet mixed in a ball mill. Then, carbon fiber was charged therein.

### Example 3

In the example 3, a positive electrode active material and a lithium ion secondary cell were produced in the similar manner to the example 2, except that the timing of charging LiOH was different.

In the example 3, before charging in a heat treatment furnace, namely, after the step of forming intermediate, LiOH was mixed.

### Comparative Example 1

In the comparative example 1, a positive electrode active material was produced by a solid phase synthesis method, and a lithium ion secondary cell were produced using the positive electrode active material.

To produce the positive electrode active material of the comparative example 1, in a similar manner to the example 1, LiOH, (NH₄)₂PO₄, and MnCO₃ were weighed and prepared, and were charged into a ball mill, and were mixed under the conditions of 400 rpm and 5 minutes.

The mixture was subjected to a heat treatment (sintered) under the similar conditions to those in the example 1.

Then, the same carbon fiber as that of the example 1 was mixed therein, and was subjected to a crushing treatment, resulting in a positive electrode active material of the comparative example 1.

### Comparative Example 2

In the comparative example 2, a positive electrode active material was produced by the synthesis method described in U.S. Pat. No. 6,528,033, and a lithium ion secondary cell was produced using the positive electrode active material.

To produce the positive electrode active material, in the similar manner to the example 1, LiOH, (N₄)₂PO₄, and MnCO₃ were weighed and prepared, and were charged into a ball mill, and were mixed under the conditions of 400 rpm and 5 minutes. Then, a carbon fiber was mixed therein.

The mixture was subjected to a heat treatment (sintered) under the similar conditions to those in the example 1.

Then, a crushing treatment was performed, resulting in a positive electrode active material of the comparative example 2.

### Comparative Example 3

In the comparative example 3, a positive electrode active material was produced by a coprecipitation synthesis method, and a lithium ion secondary cell was produced using the positive electrode active material.

To produce the positive electrode active material, in the similar manner to the example 1, LiOH and MnCO₃ were weighed and prepared. In place of (NH₄)₂PO₄ of the example 1, H₃PO₄ was weighed and prepared, and was charged together with an ion exchange water into a ball mill, followed by wet mixing under the conditions of 400 rpm and 5 minutes. The ion exchange water was used so as to achieve a solid content ratio of 80%.

The mixture was subjected to a heat treatment (sintered) under the similar conditions to those in the example 1.

Then, the same carbon fiber as that in the example 1 was mixed therein, and was subjected to a crushing treatment, resulting in a positive electrode active material of the comparative example 3.

[Evaluation]

The primary particle sizes of the lithium metal compounds of the positive electrode active materials of the respective examples and the respective comparative examples were measured, and are shown in Table 1.

Further, the results of the example 1 and the comparative example 2 were evaluated. As the evaluation, the SEM photographs of the positive electrode active materials were taken, and the positive electrode capacities of the lithium ion secondary cells were measured.

[Primary Particle Size]

Based on the SEM photograph of the positive electrode active material, six primary particles were selected. The mean value of the four primary particles, except for the particles with the maximum size and the minimum size, was obtained. The mean value is defined as the primary particle size of the lithium metal compound.

TABLE 1

| | Lithium Metal Compound | Positive Electrode |
|---|---|---|
| | Primary Particle Size (nm) | Capacity (mAh/g) |
| Example 1 | 130 | 123 |
| Example 2 | 120 | 113 |
| Example 3 | 150 | 119 |
| Comparative Example 1 | 620 | 4 |
| Comparative Example 2 | 550 | 10 |
| Comparative Example 3 | 580 | 3 |

As shown in Table 1, in the positive electrode active materials of the examples 1 to 3 the primary particles had a size of 500 nm or less. However, in the positive electrode active materials of the comparative examples 1 to 3, the primary particles had a size much larger than 500 nm.

[SEM Photograph]

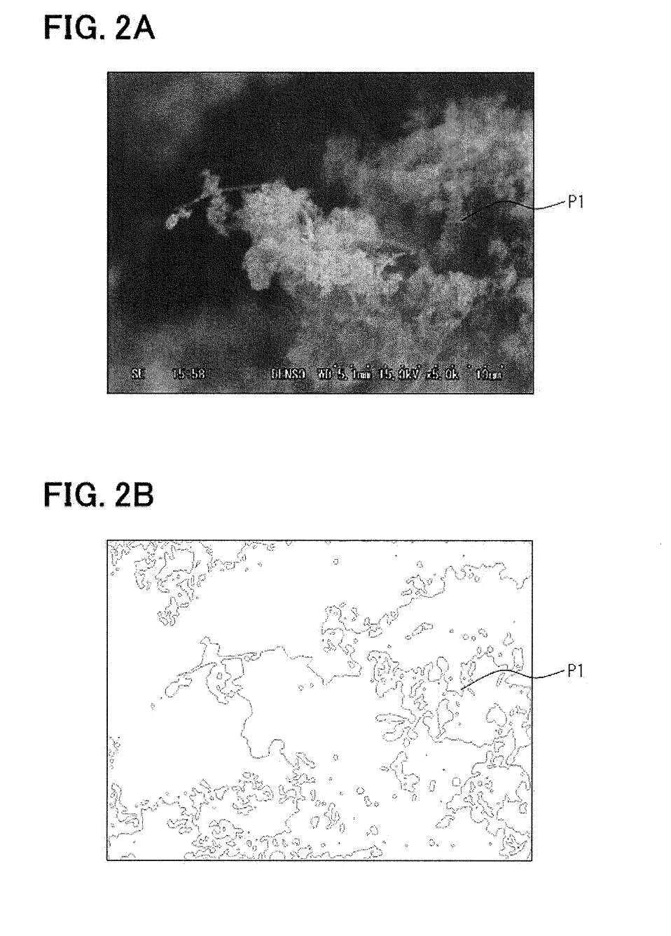

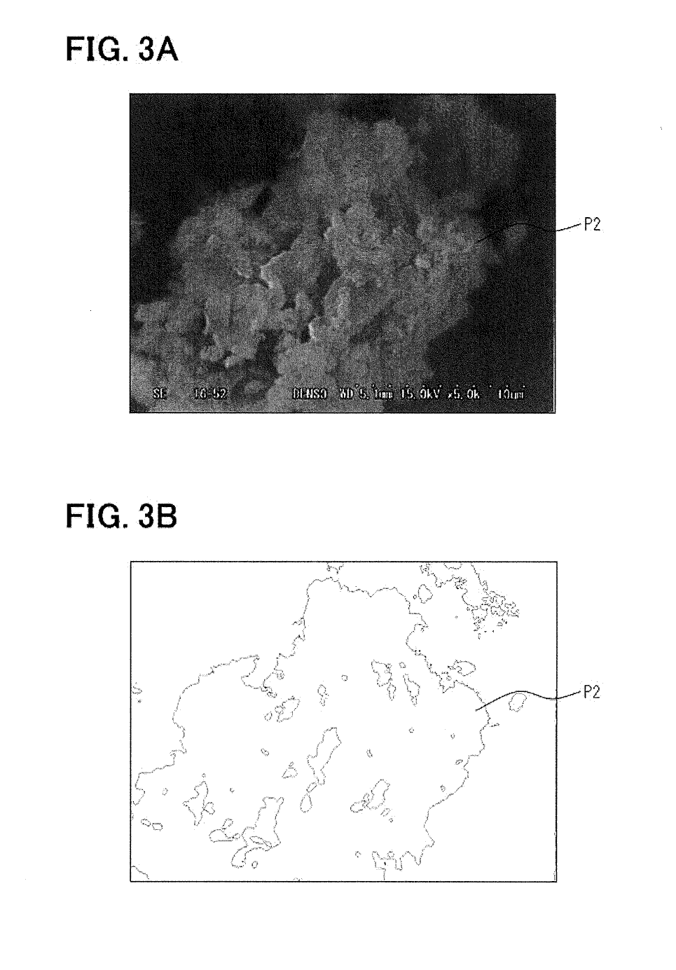

The SEM photograph of the positive electrode active material of the example 1 was taken, and is shown in FIG. 2A. The SEM photograph of the positive electrode active material of the comparative example 2 was taken, and is shown in FIG. 3A. FIGS. 2B and 3B are line diagrams of the SEM photographs of FIGS. 2A and 3A.

It was confirmed from FIGS. 2A and 2B of the example 1 that fine particles of the lithium metal compound (primary particles) P1 are formed on the surface of carbon fiber. In contrast, it was confirmed from FIGS. 3A and 3B in the comparative example 2 that particles P2 much larger than the primary particles P1 of FIGS. 2A and 2B are formed.

[Positive Electrode Capacity]

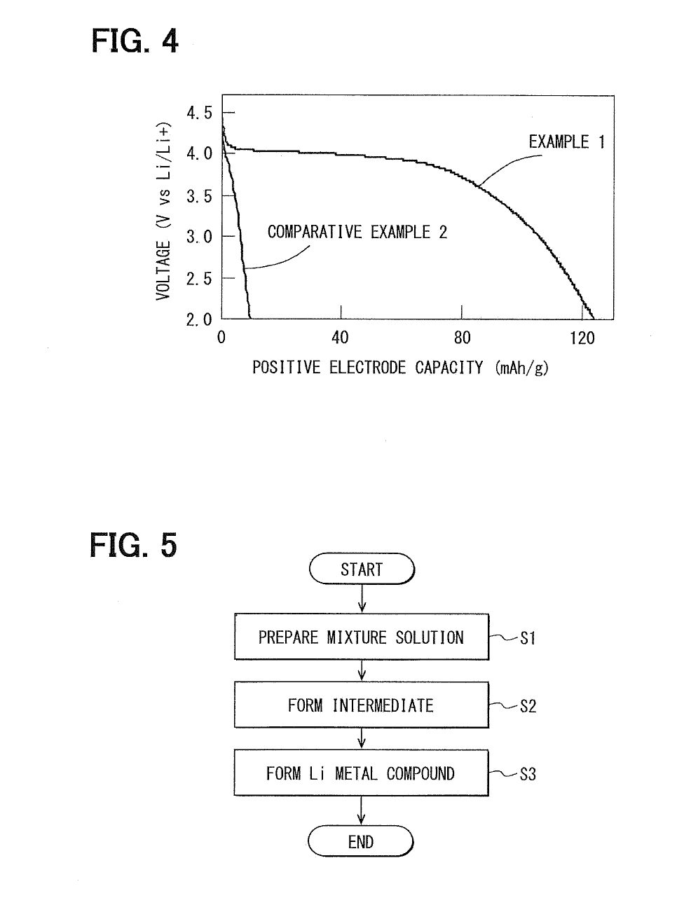

The lithium ion secondary cells of the coin type (2032 type: diameter 20.0 mm, height 3.2 mm) of FIG. 1 were formed using the positive electrode active materials of the example 1 and the comparative example 2. Further, the positive electrode capacities when the magnitude of the discharge current (discharge rate: C rate) was set at 0.1 C at a discharge temperature of 25° C. were measured. The measurement results are shown in FIG. 4.

As shown in FIG. 4, it is confirmed that the lithium ion secondary cell of the example 1 has a far higher positive electrode capacity than that of the lithium ion secondary cell of the comparative example 2.

### Example 4

In the example 4, a positive electrode active material and a lithium ion secondary cell were produced in the similar manner to the example 1, except that the pH after charging the raw materials into the citric acid aqueous solution was set at 2.1.

### Example 5

In the example 5, a positive electrode active material and a lithium ion secondary cell were produced in the similar manner to the example 1, except that water was used in place of the citric acid aqueous solution, and that the pH after charging the raw materials was set at 6.4.

### Example 6

In the example 6, a positive electrode active material and a lithium ion secondary cell were produced in the similar manner to the example 1, except that ascorbic acid was used in place of the citric acid aqueous solution, and that the pH after charging the raw materials was set at 3.1.

### Comparative Example 4

In the comparative example 4, a positive electrode active material and a lithium ion secondary cell were produced in the similar manner to the example 1, except that hydrochloric acid was used in place of the citric acid aqueous solution, and that the pH after charging the raw materials was set at 1.8.

### Comparative Example 5

In the comparative example 5, a positive electrode active material and a lithium ion secondary cell were produced in the similar manner to the example 1, except that LiOH was used in place of the citric acid aqueous solution, and that the pH after charging the raw materials was set at 8.

[Evaluation]

As the evaluation of the examples 1, and 4 to 6, and the comparative examples 4 and 5, the positive electrode capacities were measured in the similar manner to that described above. The results are shown in Table 2.

TABLE 2

| | Mixture Solution | | Positive Electrode |
|---|---|---|---|
| | pH | pH Adjuster | Capacity (mAh/g) |
| Example 1 | 3.4 | Citric acid | 123 |
| Example 4 | 2.1 | Citric acid | 128 |
| Example 5 | 6.4 | Water | 108 |
| Example 6 | 3.1 | Ascorbic acid | 114 |
| Comparative | 1.8 | Hydrochloric acid | 14 |
| Example 4 | | | |
| Comparative | 8 | LiOH | 8 |
| Example 5 | | | |

As shown in Table 2, each of the lithium ion secondary cells of the examples 1, and 4 to 6 has a positive electrode capacity of 100 (mAh/g) or more. In contrast, the lithium ion secondary cells of the comparative examples 4 and 5 have positive electrode capacities of 14 and 8 (mAh/g), respectively, which are much smaller than those of the examples 1, and 4 to 6, and hence each substantially do not function as a positive electrode.

Accordingly, it is appreciated that when the pH in the forming of the intermediate is in the range from 2 to 6.5, the positive electrode active material is excellent in electrical potential characteristics, and the lithium ion secondary cell is excellent in cell characteristics.

### Example 7

In the example 7, a positive electrode active material and a lithium ion secondary cell were produced in the similar manner to the example 1, except for using a porous carbon power (acetylene black) having a DBP oil absorption amount of 219 mg/100 g.

### Example 8

In the example 8, a positive electrode active material and a lithium ion secondary cell were produced in the similar manner to the example 1, except for using a porous carbon power (ketjen black) having a DBP oil absorption amount of 95 mg/100 g.

### Example 9

In the example 9, a positive electrode active material and a lithium ion secondary cell were produced in the similar manner to the example 1, except for using a porous carbon power (ketjen black) having a DBP oil absorption amount of 74 mg/100 g.

### Comparative Example 6

In the comparative example 6, a positive electrode active material and a lithium ion secondary cell were manufactured in the similar manner to the example 1, except for using a porous carbon power (graphite) having a DBP oil absorption amount of 36 mg/100 g.

### Comparative Example 7

In the comparative example 7, a positive electrode active material and a lithium ion secondary cell were produced in the similar manner to the example 1, except for using a porous carbon power (ketjen black) having a DBP oil absorption amount of 54 mg/100 g.

[Evaluation]

As the evaluation of the examples 1, and 7 to 9, and the comparative examples 6 and 7, the positive electrode capacities were measured in the same manner as described above. The results are shown in Table 3.

TABLE 3

| | Conductive | DBP Oil Absorption | Positive Electrode |
|---|---|---|---|
| | Matrix | Amount (mg/100 g) | Capacity (mAh/g) |
| Example 1 | Vapor-grown | 231 | 123 |
| | carbon fiber | | |
| Example 7 | Acetylene black | 219 | 110 |
| Example 8 | Ketjen black | 95 | 101 |
| Example 9 | Ketjen black | 74 | 103 |
| Comparative | Graphite | 36 | 51 |
| Example 6 | | | |
| Comparative | Ketjen black | 54 | 60 |
| Example 7 | | | |

As shown in Table 3, each of the lithium ion secondary cells of the examples 1, and 7 to 9 has a positive electrode capacity of 100 (mAh/g) or more. In contrast, the lithium ion secondary cells of the comparative examples 6 and 7 have positive electrode capacities of 51 and 60 (mAh/g), respectively, which are much smaller than those of the examples 1, and 7 to 9.

Accordingly, it is appreciated that when the DBP absorption amount of the conductive matrix becomes larger than a prescribed value, a positive electrode active material is excellent in electrical potential characteristics, and a lithium ion secondary cell is excellent in cell characteristics.

While only the selected exemplary embodiment and examples have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiment and examples according to the present disclosure is provided for illustration only, and not for the purpose of limiting the disclosure as defined by the appended claims and their equivalents.

What is claimed is:

1. A positive electrode active material comprising:
a conductive matrix; and
a lithium metal compound of a polyanion structure provided on a surface of the conductive matrix, the lithium metal compound being expressed as Li_{α}M⁰_{β}X_{η}O_{4-γ}Z_{γ}, wherein
M⁰ is one or more selected from Mn, Co, Ni, Fe, Cu, Cr, Mg, Ca, Zn, and Ti,
X is one or more selected from P, As, Si, Mo, and Ge,
Z is one or more selected from Al, Mg, Ca, Zn, and Ti, being optionally includable,
α satisfies 0≦α≦2.0,
β satisfies 0≦β≦1.5,
η satisfies 1≦η≦1.5, and
γ satisfies 0≦γ≦1.5.

2. The positive electrode active material according to claim 1, wherein the lithium metal compound is expressed as Li_{α}Mn_{∈}M¹_{1-∈}X_{η}O_{4-γ}Z_{γ}, wherein
∈ is 0.6 or more,
M¹ is one or more selected from Co, Ni, Fe, Cu, Cr, Mg, Ca, Zn, and Ti,
X is one or more selected from P, As, Si, Mo, and Ge,
Z is one or more selected from Al, Mg, Ca, Zn, and Ti, being optionally includable,
α satisfies 0≦α≦2.0,
β satisfies 0≦β≦1.5,
η satisfies 1≦η≦1.5, and
γ satisfies 0≦γ≦1.5.

3. The positive electrode active material according to claim 1, wherein the conductive matrix is formed of carbon.

4. The positive electrode active material according to claim 1, wherein the conductive matrix is a carbon fiber assembly.

5. The positive electrode active material according to claim 1, wherein the lithium metal compound is a primary particle with a size of 500 nm or less.

6. A method for manufacturing a positive electrode active material having a lithium metal compound of a polyanion structure granulated on a surface of a conductive matrix, the lithium metal compound being expressed as Li_{α}M⁰_{β}X_{η}O_{4-γ}Z_{γ}, in which: M⁰ is one or more selected from Mn, Co, Ni, Fe, Cu, Cr, Mg, Ca, Zn, and Ti; X is one or more selected from P, As, Si, Mo, and Ge; Z is one or more selected from Al, Mg, Ca, Zn, and Ti, being optionally includable; α satisfies 0≦α≦2.0; β satisfies 0≦β≦1.5; η satisfies 1≦η≦1.5; and γ satisfies 0≦γ≦1.5, the method comprising:
preparing a mixture solution in which an M compound as an M⁰ source, an X compound as an X source, a Z compound as a Z source, and a conductive matrix are dispersed;
forming an intermediate formed of a hydrate of M⁰ from the M compound; and
forming the lithium metal compound by reacting a Li compound as a Li source and the intermediate with each other through a heat treatment.

7. The method for manufacturing a positive electrode active material according to claim 6, wherein the forming of the intermediate is proceeded at 60° C. or less.

8. The method for manufacturing a positive electrode active material according to claim 6, wherein in the forming of the intermediate, the mixture solution has a pH of 2 to 6.5.

9. The method for manufacturing a positive electrode active material according to claim 8, wherein the pH of the mixture solution is adjusted by an organic acid.

10. The method for manufacturing a positive electrode active material according to claim 6, wherein the conductive matrix has a dibutyl phthalate oil absorption amount of 70 ml/100 g or more.

11. A nonaqueous electrolyte secondary cell comprising:
a positive electrode having the positive electrode active material according to claim 1;
a negative electrode; and
an electrolyte.

12. A nonaqueous electrolyte secondary cell comprising:
a positive electrode having the positive electrode active material manufactured by the method according to claim 6;
a negative electrode; and
an electrolyte.
